(19) United States
(12) Patent Application Publication
(10) Pub. No.: US 2024/0325900 A1
(43) Pub. Date: Oct. 3, 2024

(54) NON-TRANSITORY COMPUTER-READABLE MEDIUM AND VIDEO GAME PROCESSING SYSTEM

(71) Applicant: SQUARE ENIX CO., LTD., Tokyo (JP)

(72) Inventors: Kazutoyo MAEHIRO, Tokyo (JP); Momoka AONO, Tokyo (JP)

(73) Assignee: SQUARE ENIX CO., LTD., Tokyo (JP)

(21) Appl. No.: 18/620,726

(22) Filed: Mar. 28, 2024

(30) Foreign Application Priority Data
Mar. 31, 2023 (JP) 2023-058932

(51) Int. Cl. A63F 13/537; A63F 13/35; A63F 13/45

(52) U.S. Cl. CPC A63F 13/537; A63F 13/35; A63F 13/45

(57) ABSTRACT

One or more embodiments of the disclosure provide a non-transitory computer-readable medium storing a video game processing program that, when, executed, causes a server to perform: controlling progress of a video game; displaying a game screen based on a progress status of the video game; extracting a description of a term corresponding to the progress status of the video game from a predetermined storage area based on information different from text displayed on the game screen; and providing the extracted description of the term to a player.

### CROSS-REFERENCE TO RELATED APPLICATION

The present application claims priority to and the benefit of Japanese Patent Application No. 2023-058932 filed on Mar. 31, 2023, the disclosure of which is expressly incorporated herein by reference in its entirety for any purpose.

### BACKGROUND

Conventionally, in the field of text-based video games (Video games centered on reading text displayed on a game screen), various systems have been proposed for displaying a description of a specific term included in a text displayed on a game screen on a player.

In such a system, for example, there is a system in which a word and a description of the word are stored in association with each other, and a description of a specific word included in a text displayed on a display screen is displayed. Examples of such systems may be found in Japanese Patent Application Publication No. 2008-237846 A

### SUMMARY

However, in the conventional system, only a description of a term included in a text displayed on a game screen is displayed, and there is a case where convenience is lacking. That is, there is a case where a valid description cannot be obtained when knowledge of not a term included in a text read by the player itself but a term related to the term and a game screen being displayed is required.

It is an object of at least one embodiment of the present invention to realize a video game processing program and a video game processing system capable of providing more effective information to a player.

According to a non-limiting aspect, a video game processing program according to an embodiment of the present invention is a video game processing program for causing a server to realize a function of controlling progress of a video game, the program comprising: a displaying function of displaying, on the server, a game screen based on a progress status of the video game; and an extracting function of extracting a description of a term corresponding to the progress status of the video game from a predetermined storage area based on information different from text displayed on the game screen, a providing function of providing the description of the term extracted by the extracting function to a player is realized.

According to a non-limiting aspect, a video game processing system according to an embodiment of the present invention includes a communication network, a server, and a player terminal, and controls progress of a video game in response to an operation of the player, wherein the video game includes: displaying means for displaying a game screen based on a progress status of the video game; extracting means for extracting a description of a term corresponding to the progress status of the video game from a predetermined storage area based on information different from text displayed on the game screen; and providing means for providing the description of the term extracted by the extracting means to a player.

According to a non-limiting aspect, a video game processing program according to an embodiment of the present invention is a video game processing program for causing a player terminal to realize a function of controlling progress of a video game, the program comprising: a displaying function of displaying a game screen on the player terminal based on a progress status of the video game; and an extracting function of extracting a description of a term corresponding to the progress status of the video game from a predetermined storage area based on information different from text displayed on the game screen, a providing function of providing the description of the term extracted by the extracting function to a player is realized.

According to each embodiment of the disclosure, one or more problems are solved.

### BRIEF DESCRIPTION OF DRAWINGS

FIG. 1 is a block diagram showing an example of a configuration of a video game processing system according to at least one embodiment of the present invention;

FIG. 2 is a block diagram showing a configuration of a server corresponding to at least one embodiment of the present invention;

FIG. 3 is a flowchart showing an example of game processing corresponding to at least one embodiment of the present invention;

FIG. 4 is a flowchart showing an example of an operation on a server side in a game process corresponding to at least one embodiment of the present invention;

FIG. 5 is a flowchart showing an example of an operation on a terminal side in a game process corresponding to at least one embodiment of the present invention;

FIG. 6 is a block diagram showing a configuration of a server corresponding to at least one embodiment of the present invention.

FIG. 7 is a flowchart showing an example of game processing corresponding to at least one embodiment of the present invention.

FIG. 8 is an explanatory diagram for explaining an example of a storage state of information corresponding to at least one embodiment of the present invention;

FIG. 9 is an explanatory diagram showing an example of a game screen corresponding to at least one embodiment of the present invention;

FIG. 10 is an explanatory diagram showing an example of a game screen corresponding to at least one embodiment of the present invention;

### DETAILED DESCRIPTION

Embodiments of the present invention will now be described with reference to the accompanying drawings. Note that various constituent elements in the examples of the embodiments described below can be appropriately combined as long as there is no contradiction or the like. In addition, description of contents described as an example of one embodiment may be omitted in other embodiments. In addition, the contents of operations and processes that are not related to the characteristic portions of the embodiments may be omitted. Further, the order of the various processes constituting the various flows described below is not the same as long as the contents of the processes do not contradictory.

### First Embodiment

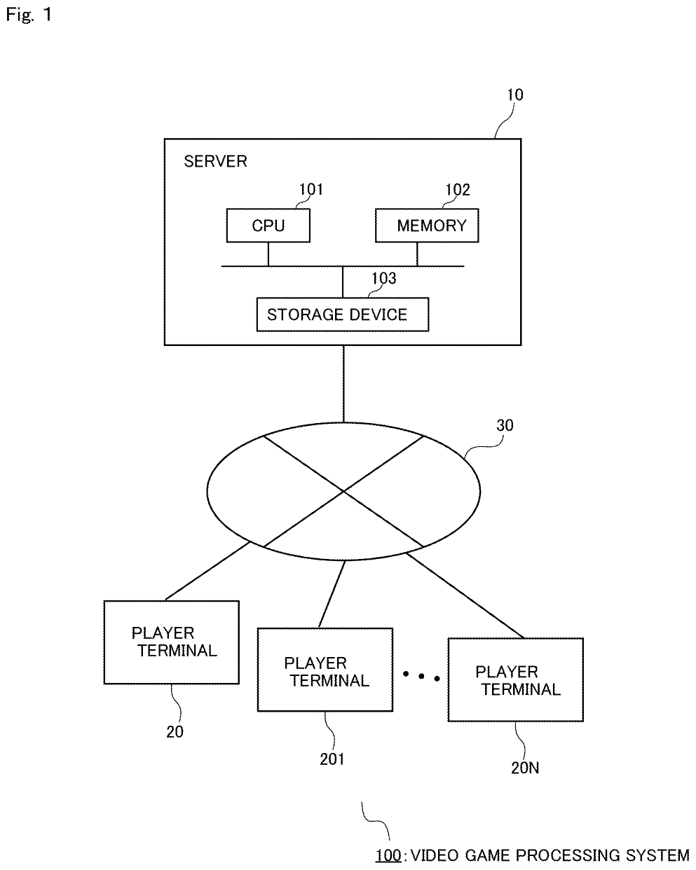

FIG. 1 is a block diagram showing an example of a configuration of a video game processing system 100 according to an embodiment of the present invention. As shown in FIG. 1, the video game processing system 100 includes a video game processing server 10 (server 10) and player terminals (player terminals) 20, 201 to 20N (N is an arbitrary integer) used by a player (player) of the video game processing system 100. The configuration of the video game processing system 100 is not limited thereto, and a plurality of players may use a single player terminal, or a plurality of servers may be provided.

The server 10 and the plurality of player terminals 20, 201 to 20N are connected to a communication network 30 such as the Internet. Although not shown, the plurality of player terminals 20, 201 to 20N are connected to the communication network 30 by performing data communication with a base station managed by a communicator through a wireless communication line.

The video game processing system 100 includes a server 10 and a plurality of player terminals 20 and 201 to 20N, thereby realizing various functions for executing various kinds of processing in accordance with an operation of a player.

The server 10 is managed by an administrator of the video game processing system 100, and has various functions for providing information about various processes to a plurality of player terminals 20, 201 to 20N. In this example, the server 10 is configured by an information processing apparatus such as a WWW server, and includes a storage medium for storing various kinds of information. The configuration of the server 10 is not particularly limited as long as it includes a general configuration for performing various types of processing as a computer such as a control unit and a communication unit. Hereinafter, an example of the hardware configuration of the server 10 will be briefly described.

As shown in FIG. 1, the server 10 includes at least CPU (Central Processing Unit) 101, a memory 102, and a storage device 103.

The CPU 101 is a central processing unit that performs various calculations and controls. Further, when the server 10 includes a GPU (Graphics Processing Unit), a part of various calculations and control may be performed by the GPU. The server 10 causes the CPU 101 to execute various kinds of information processing necessary for controlling the video game using the data appropriately read out to the memory 102, and stores the obtained processing result in the storage device 103 as necessary.

The storage device 103 functions as a storage medium for storing various kinds of information. The configuration of the storage device 103 is not particularly limited, but from the viewpoint of reducing the processing load on each of the plurality of player terminals 20, 201 to 20N, it is preferable that the storage device 103 is configured to store all of various kinds of information necessary for controlling the video game. Such examples include HDDs and SSDs. However, the storage unit for storing various kinds of information only needs to be provided with a storage area in a state accessible by the server 10, and for example, a dedicated storage area may be provided outside the server 10.

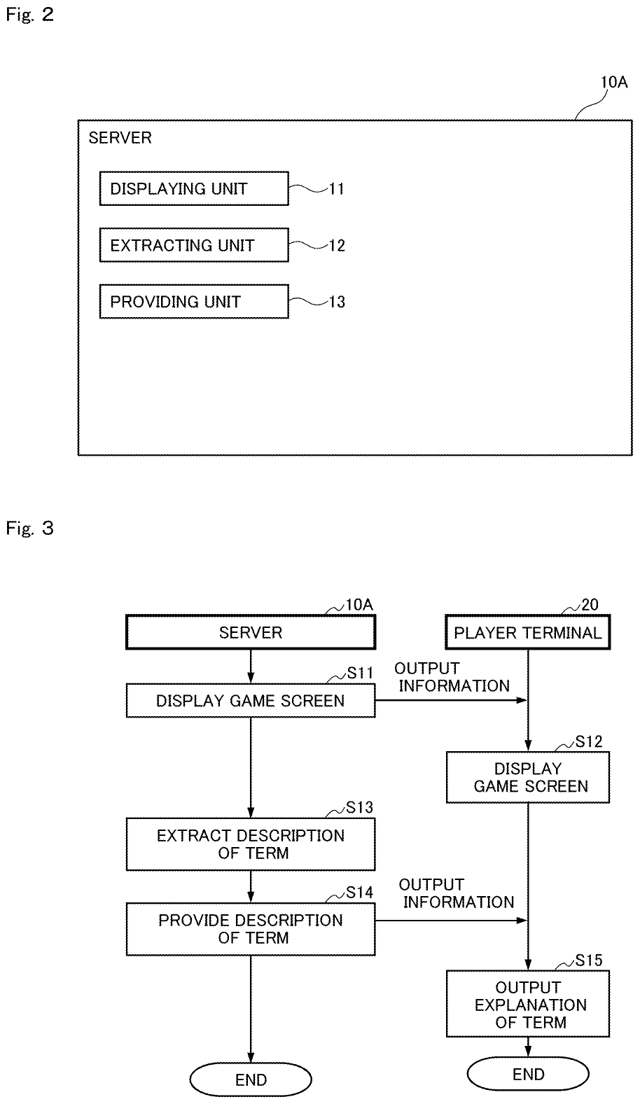

FIG. 2 is a block diagram showing a configuration of a video game processing server 10A (server 10A), which is an example of the configuration of the video game processing server 10. As shown in FIG. 2, the server 10A includes at least a displaying unit 11, an extracting unit 12, and a providing unit 13.

The displaying unit 11 has a function of displaying a game screen based on the progress status of the video game.

Here, the progress status of the video game means various progress states that can occur in the video game. The progress status of the video game is not particularly limited, but it is preferable that the progress state be recognized by the player. Examples of the progress status of the video game include a state in which the scenario progresses, a state in which a moving image is reproduced in the video game, and a state in which the position of the player or the position of the character changes. Note that the progress status of the video game in this example includes a status in which the player has selected moving image reproduction on a UI (moving image reproduction menu) or the like in which an event scene is switched back. That is, the information specified as the progress status of the video game includes information specifying a moving image reproduced in response to a player operation.

The game screen means a screen for displaying an image related to progress of the video game. The configuration of the game screen is not particularly limited as long as the player can recognize the status of the video game. Examples of the configuration of the game screen include an image representing the progress of the scenario, an image of the virtual space, an image of the character, and an image representing the position of the player.

The configuration for displaying the game screen is not particularly limited as long as the player can recognize the progress status of the video game. That is, for example, a configuration may be adopted in which a screen is generated and transmitted to the terminal, or information for generating the screen may be transmitted to the terminal by the terminal.

The extracting unit 12 has a function of extracting a description of a term corresponding to the progress status of the video game from a predetermined storage area based on information different from the text displayed on the game screen.

Here, information different from text means information different from information expressed as text in a video game. Examples of such information include an image representing a virtual space appearing in a video game, a character, and a building, and a cut scene or a moving image reproduced in the video game. Since it is intended to eliminate the need to extract a description of a term based on a text displayed on the game screen, a configuration may be adopted in which a portion that can be recognized by the player as a text is allowed to be included in an image or a moving image. With such a configuration, it becomes possible to provide information to the player from a different point of view from the conventional system which provides a player with a description associated with a text displayed on a game screen.

The configuration for extracting the description of the term corresponding to the progress status of the video game is not particularly limited, but it is preferable that the player can recognize the relationship between the status and the description. Such examples include a configuration in which an explanatory text is extracted from information in which a situation and an explanatory text are associated with each other as a search key, and a configuration in which an explanatory text is extracted from information in which a term specified from the situation and the explanatory text are associated with each other as a search key. In this case, the configuration for specifying the term from the situation is not particularly limited, and a predetermined database in which the situation and the term are associated with each other may be used, or a predetermined generation rule for specifying the term from the situation may be used. Examples of identification rules include rules for identifying names of elements (e.g., characters and buildings) in a game displayed on a game screen as terms. When the name of the element in the game is changed by the player, the description may be updated. In an example of such a configuration, when the player sets or changes the name of the game character, the name portion of the game character in the description text is replaced with the set or changed name.

The timing of extracting the description is not particularly limited, and may be a timing at which the progress status of the video game satisfies a predetermined extraction condition, or a timing at which the player inputs a predetermined operation. Examples of predetermined extraction conditions include the progress of a scenario and the playback of a video in a video game. Examples of the predetermined operation include an operation for displaying a screen for confirming a description of a term. Further, the description may be always extracted during the game activation. In this case, for example, even in a situation where the player cannot open the screen for confirming the description of the term, the determination and term extraction are performed in real time on the back side even if the player cannot open the screen for confirming the description of the term, and the screen appears on the screen only when the player opens the UI.

The providing unit 13 has a function of providing the description of the term extracted by the extracting unit 12 to the player.

Here, the configuration for providing the description to the player is not particularly limited as long as the configuration enables the player to recognize the description. Examples of the configuration for providing the description to the player include a configuration in which the description is displayed in a display area provided separately from the game screen, and a configuration in which a sound for reading the description is output to the player using a sound output means.

Each of the plurality of player terminals 20, 201 to 20N is managed by a player, and is configured by a mobile phone terminal, PDA (Personal Digital Assistants), a mobile game apparatus, a communication terminal capable of performing a network distribution type game such as a so-called wearable device, or the like. The configuration of the player terminal that can be included in the video game processing system 100 is not limited to the above-described example, and may be any configuration as long as the player can recognize the contents of the video game. Other examples of the configuration of the player terminal include a combination of various communication terminals, a personal computer, and a stationary game apparatus.

Each of the plurality of player terminals 20, 201 to 20N is connected to the communication network 30, and includes hardware (For example, a display device or the like that displays a browser screen or a game screen according to coordinates.) and software for executing various processes by communicating with the server 10. The plurality of player terminals 20, 201 to 20N may be configured to communicate directly with each other without passing through the server 10.

Next, the operation of the video game processing system 100 (system 100) of the present embodiment will be described.

FIG. 3 is a flowchart showing an example of game processing executed by the system 100. In the game process in this example, a process related to controlling the progress of the video game in accordance with an operation of a player of the player terminal 20 (terminal 20) is performed. Hereinafter, a case where the server 10A and the terminal 20 execute game processing will be described as an example.

The game process is started, for example, when the server 10A determines that a condition (preparation condition) for starting preparation for providing a description of a term is satisfied.

In the game processing, the server 10A first displays a game screen (step S11). In this example, the server 10A generates output information for causing the terminal 20 to output a game screen based on the progress status of the video game, and transmits the generated output information to the terminal 20.

The terminal 20 outputs a game screen to a display screen of a predetermined display device based on the output information received from the server 10A (step S12). After outputting the game screen, the terminal 20 transmits operation information received from the player to the server 10A, thereby causing the server 10A to progress the video game.

When the game screen is displayed, the server 10A extracts a description of a term (step S13). In this example, the server 10A extracts a description of a term corresponding to the progress status of the video game from a predetermined storage area based on information different from the text displayed on the game screen displayed by the terminal 20.

When extracting the description, the server 10A provides the description of the term (step S14). In this example, the server 10A generates output information for causing the player terminal 20 to output the extracted description of the term, and transmits the generated output information to the player terminal 20.

The terminal 20 outputs the description of the term based on the output information received from the server 10A (step S15). After outputting the game screen, the terminal 20 transmits operation information received from the player to the server 10A, thereby causing the server 10A to progress the video game.

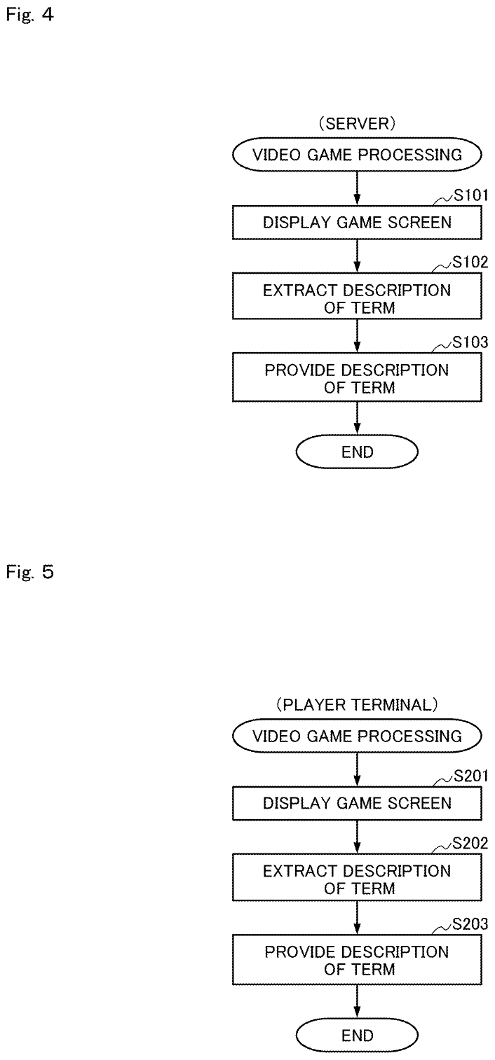

FIG. 4 is a flowchart showing an example of the operation of the server 10A in the game process. Here, the operation of the server 10A in the system 100 will be described again.

In the game processing, the server 10A first displays a game screen (step S101), extracts a description of a term (step S102), and provides the description of the term (step S103).

FIG. 5 is a flowchart showing an example of the operation of the terminal 20 when the terminal 20 executes the game process. Hereinafter, a case where the terminal 20 executes a game process by itself will be described as an example. The terminal 20 has functions similar to those of the server 10 except that the terminal 20 receives various kinds of information from the server 10, and therefore description thereof is omitted from the viewpoint of avoiding redundant description.

In the game process, the terminal 20 first displays a game screen (step S201), extracts a description of a term (step S202), and provides the description of the term (step S203). In this example, the terminal 20 communicates with the server 10A to obtain information used in each step. Note that the terminal 20 may identify information to be used in each step by referring to a storage unit included in the terminal 20.

As described above, as one aspect of the first embodiment, since the server 10A that controls the progress of the video game is configured to include the displaying unit 11, the extracting unit 12, and the providing unit 13, the server 10A displays a game screen based on the progress status of the video game, extracts a description of a term corresponding to the progress status of the video game from a predetermined storage area based on information different from the text displayed on the game screen, and provides the extracted description of the term to the player, it is possible to provide more effective information to the player.

That is, it becomes possible to provide the player with a description of a term in accordance with the situation of the player without being bound by the text displayed on the game screen.

### Second Embodiment

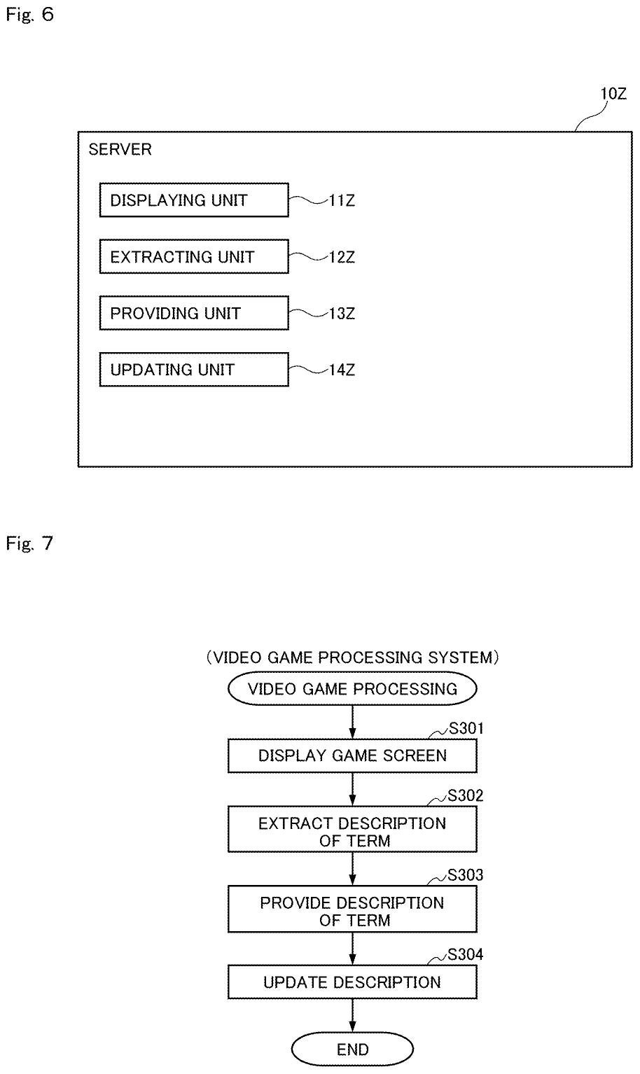

FIG. 6 is a block diagram showing a configuration of a video game processing server 10Z (server 10Z), which is an example of the video game processing server 10. In this example, the server 10Z includes at least a displaying unit 11Z, an extracting unit 12Z, a providing unit 13Z, and an updating unit 14Z.

The displaying unit 11Z has a function of displaying a game screen based on the progress status of the video game.

Here, the progress status of the video game means various progress states that can occur in the video game. In this example, the displaying unit 11Z displays a moving image to be reproduced regardless of the player's operation.

The extracting unit 12Z has a function of extracting a description of a term corresponding to the progress status of the video game from a predetermined storage area based on information different from the text displayed on the game screen.

Here, information different from text means information different from information expressed as text in a video game. In this example, the extracting unit 12Z extracts a description of a term corresponding to the reproduction status of a moving image from a predetermined storage area. Note that the extracting unit 12Z may be configured to extract a description related to the position of the player or the character operated by the player in the virtual space from a predetermined storage area. Further, the extracting unit 12Z may be configured to extract a description related to a sequence (a progress status of a word in a free operation) from a predetermined storage area.

The providing unit 13Z has a function of providing the description of the term extracted by the extracting unit 12Z to the player.

Here, the configuration for providing the description to the player is not particularly limited as long as the configuration enables the player to recognize the description. In this example, when receiving a description request from the player, the providing unit 13Z provides at least a part of the extracted description of the term to the player. It should be noted that the providing unit 13Z may be configured to use only an image or sound in order to describe the term to the player.

The updating unit 14Z has a function of updating the description corresponding to the player based on the progress of the video game by the player.

Here, the configuration for associating the player with the description is not particularly limited, but it is preferable that the player can recognize that the description changes in accordance with the progress of the video game. In an example of such a configuration, when a player satisfies an update condition based on the progress of a video game, update contents corresponding to the satisfied update condition are reflected in the description (For example, when the player P1 defeats the enemy character E1, the description of the family experience is added to the description of the enemy character E1.).

FIG. 7 is a flowchart showing an example of game processing corresponding to at least one embodiment of the present invention. In the game processing in this example, processing relating to controlling the progress of the video game in accordance with an operation of the player is performed. Each process performed by the video game processing system 100Z including the server 10Z will now be described. Note that the order of the respective processes is not the same as long as there is no contradiction in the contents of the processes.

The game process is started, for example, when the system 100Z receives an operation input by the player.

In the game processing, the system 100Z first displays a game screen (step S301). In this example, the system 100Z displays, as a game screen, a screen indicating a state of a video game progressed in response to a player operation.

When the game screen is displayed, the system 100Z extracts a description of a term (step S302). In this example, the system 100Z extracts a description of a term from a predetermined storage area as description information which is considered to be effective for providing to a player in accordance with progress of a video game.

After extracting the description of the term, the system 100Z provides the description of the term (step S303). In this example, the system 100Z provides the player with the description of the term in a predetermined format via a game screen.

After providing the description of the term, the system 100Z updates the description (step S304). In this example, when the player satisfies the update condition, the system 100Z reflects the update contents corresponding to the satisfied update condition in the description.

Hereinafter, a configuration for providing a description of a term to a player in this example will be described in more detail.

In this example, the system 100Z displays a dedicated browsing menu in which displayed items are switched, mainly in accordance with the progress of the main story of the video game.

Here, the dedicated browsing menu means a dedicated browsing menu in which the player can confirm “information in which the understanding of the main story becomes deeper” at any time. It is preferable that the dedicated browsing menu has a simple access to solve the “non-wrinkling . . . ” of the object, and it is preferable that the dedicated browsing menu be configured to be able to be immediately examined when the player is aware. That is, it is preferable that a dedicated browsing menu can be utilized as means for immediately self-resolving a portion which the player seems not to know. Further, it is preferable that the dedicated browsing menu has a configuration in which important terms “current” can be known for the player. As an example of such a configuration, it is preferable to have a configuration in which the operation can be performed at any time during a so-called cut scene or an event or during a free operation. Further, the dedicated browsing menu is not a game belonging to a so-called text adventure, but can provide a description of a term to the player in real time even in a game centered at a cut scene, for example. That is, for example, a system (e.g., text adventure or text-based event) in which text is displayed and progresses in conjunction with sound requires “characters” or “words” to access words to be known. On the other hand, in the dedicated browsing menu in this example, terms can be switched and displayed using voice labels. Therefore, unlike the text adventure, the display period of the item can be set based on the voice label which is a unit of the serif of the sound data without adding a description of the item to the “word” in the serif.

The item denotes information to be provided to the player. The configuration for associating the information provided to the player with the item is not particularly limited, but is preferably a configuration that allows the player to understand the outline of the information. Examples of information and items to be provided to the player include description information including description texts of terms appearing in the video game and terms thereof. Note that the configuration of the description information is not particularly limited, and may include a moving image for description and supplementary information.

It should be noted that the voice control may be used to switch the items after the reproduction of the moving image (e.g., cut scene) progressing without depending on the operation of the player is started in accordance with the progress of the video game and before the reproduction of the operation is finished. Further, in the field/stage in the free operation which is not in the cut scene, by using the voice control to switch the items for the talk uttered by the player character, the party member, the placement NPC, or the like, more detailed switching may be made possible. Further, in the above description, an example has been mainly described in which the items are switched in order to prevent the nodule of the word, but the use method of the voice control is not limited thereto. That is, as an example of another type of method of use, during an in-game, for example, in an action game, when a specific combo occurs in response to a player operation, voice control may be used to display information relating to the generated combo (for example, a description of a condition or effect of the combo). Further, when a “sound of a specific monster” occurs, a description of a term for describing a living organism corresponding to the sound may be displayed in accordance with a player operation. In this case, the voice control information in which the voice is associated with the description information may be used.

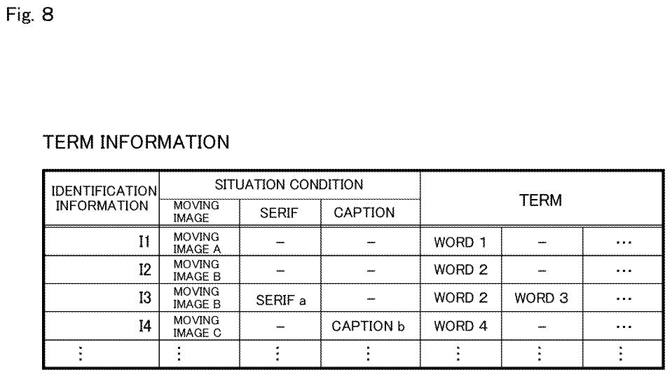

FIG. 8 is an explanatory diagram for explaining an example of term information used for extracting a term. As shown in FIG. 8, in this example, in the term information, identification information, situation conditions, and terms are associated with each other.

Here, the situation condition means a condition for specifying a term to be extracted. Examples of the situation condition are not particularly limited, but it is preferable that the player can recognize the correspondence between the condition and the term. In this example, the conditions include moving images, serifs, and captions.

Further, the correspondence relationship between the situation conditions and the terms is not particularly limited, but it is preferable that the number of terms that can be recognized by the player is associated with the situation conditions.

The items displayed in this example are controlled in accordance with the progress of the video game. That is, the information provided to the player as the description information is switched depending on the progress of the main story or the action of the player. As a method of switching information, the items of information to be provided to the player are not increased, but the information itself to be provided is updated. That is, a predetermined “keyword” is displayed as an item based on the current player situation. However, the increase/decrease of the number of items displayed at once is not denied, and the number of items may be partially increased, for example. That is, for example, the number of display items may be increased by a predetermined number in accordance with the speech of the cut scene.

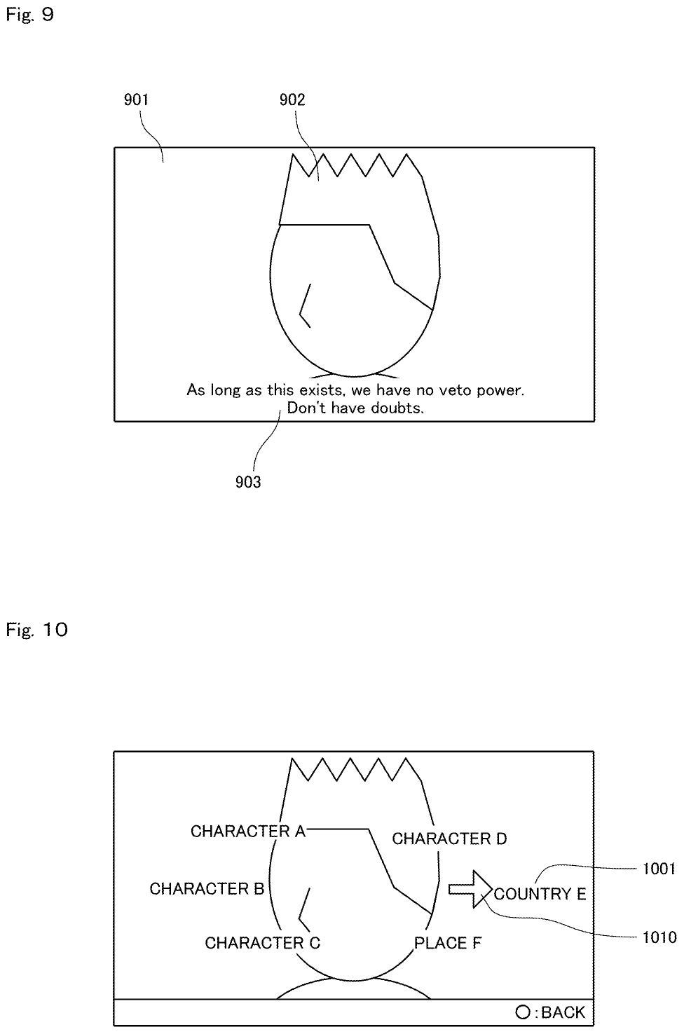

FIG. 9 is an explanatory diagram for explaining an example of a game screen; In an example of the game screen shown in FIG. 9, an area 901 for displaying a virtual space, a character 902, and a serif 903 of the character are displayed. Here, for example, when the player inputs a predetermined operation, at least one item is displayed on the game screen. Examples of the predetermined operation include an operation of long-pressing a predetermined touch pad of the controller held by the player and an operation of single-pressing (e.g., tapping) a predetermined touch pad after a predetermined button (e.g., an option button) is pressed and poses (i.e., in a state in which a cut scene is stopped). When item display is prohibited, a mark indicating prohibition of item display is displayed on the game screen.

FIG. 10 is an explanatory diagram for explaining another example of the game screen. In the example of the game screen shown in FIG. 10, a plurality of words (for example, character A, character B, country E, place F) are displayed as a plurality of items. Here, for example, when the player operates the cursor 1010 to select the item 1001, information (e.g., description text) corresponding to the item 1001 is displayed on the game screen.

Further, when providing information based on the current position of the player, items associated with an area where the player is located are provided to the player. When providing information based on the sequence of the player, items associated with the game progress of the player are provided to the player. In this case, for example, the information may be provided based on the sequence only during the free operation. Further, in the case of providing information based on a situation in a cut scene or a conversation event, an item associated with a condition satisfied during reproduction of the cut scene is provided to the player. That is, for example, at the start of a cut scene, the same item as that of the immediately preceding sequence is displayed, and when the condition is satisfied by a predetermined caption according to the progress of the cut scene, the provision information is switched to the item associated with the condition. When the condition is satisfied by a predetermined speech according to the progress of the cut scene, the provision information is switched to the item associated with the condition.

In this example, there are three main conditions for controlling items: 1. “Player status” (quest sequence), 2. “Cut scene control”, and 3. “Response according to location”. In addition, the Player status includes flag management (sequence) by progress of the main story, progress of the quest, access of the NPC, enemy subjugation, letter, or the like. Various cut scenes and event scenes are associated with cut scene control. Further, the Response according to location includes the time when it is in the “field AJITO stage” and the time when it is in the “dropout stage”.

In the cut scene control in this example, control is performed in two stages, i.e., in units of cut scenes and in units of serifs. In the case where the control is performed in units of cut scenes, the item display condition is a condition during reproduction of each cut/event. Further, when the control is performed in units of serifs (In other words, when the speech of the serif in the cut scene or the event is used as a trigger,), the additional display of the items is performed by using the time of serif reproduction/end of the voice clip as a trigger, and the additional display of the items is performed in the cut scene by designating the voice label ID of the serif. With such a configuration, it is possible to follow information that the player wishes to know without negligibility. A “management ID of cut scenes or events” and a “voice label or caption label (management ID)” are set for voice data control. In this example, a signal is sent at the time of voice utterance of a cut scene or an event, prepare separate interfaces for the cut side and the event side, and the voice controller controls the interface.

The configuration for providing the item to the player is not particularly limited, but it is preferable that the configuration does not impair the visibility of the game screen. Examples of such a configuration include a configuration in which the size of an item is varied based on an index (e.g., importance) corresponding to the item, and a configuration in which the number of items to be displayed is added or deleted depending on the situation.

In this example, the information held by the items is managed in a predetermined database. The items in the database are updated such that the number of pages is increased or the image is changed in accordance with the progress of the story. When the item is selected by the player, two methods can be adopted: a method in which the number of pages is directly designated and displayed, and a method in which the latest page of the word is automatically determined and displayed. Here, when the latest page is displayed, the latest page is specified corresponding to the player status. Examples of the case of directly designating and displaying the number of pages (i.e., the case of ignoring the player status) include cut scenes and replay stages. In other words, when the latest item is automatically displayed, if the item cannot be combined with an object, a database in which pages to be displayed are directly set is used. In addition, the number of pages may be directly specified when an item is selected not only in a cut scene or a replay stage but also in almost all situations. The reason for such a configuration is that, for example, in the second play in which the player performs the so-called “good new game”, since the progress status of the story is reset in a state in which the contents of the database (registration status of the player) referred to as information corresponding to the player are taken over, it is necessary to see not the registration status of the database of the player but the progress degree of the object word of the player. In other words, by automatically controlling the current position (aggregation) of the player so as to change the number of pages, and switching the current position according to the state of the progress of the story in the second round, it is possible to display the page according to the state of the player.

When the current position of the character operated by the player is displayed, the current position of the character is displayed using the determination using the predetermined map information and the division information. At this time, the words displayed together with the position display in the main menu can also be viewed in the dedicated browsing menu. The current position display may be canceled during a cut scene in which a character does not appear.

Further, the displayed items may be controlled by optionally giving a display priority to a specific spot (That is, a special area in the virtual space. Special Area.) such as a field and a collection or landmark existing on the field. In this case, in the case of the same priority, all the items that satisfy the conditions may be displayed (the maximum number or more are not displayed), and in the case of the different priority, the items may be exclusively displayed. Examples of the priorities include a cut scene, a specific play scene (replay, specific quest score attack), and a player status (main quest sequence) in this order. Further, a display object when a plurality of conditions match may be controlled according to the priority.

Further, only the items associated with the conditions during the cut scene reproduction and during the cut scene reproduction may be displayed. As an example of such a configuration, when the “cut scene: CUT 1600” is reproduced in the situation of the “main quest sequence: 00750” as the progress of the game, only the item associated with the “cut scene: CUT 1600” is displayed by setting the higher priority than the main quest sequence to the cut scene, and the item associated with the “main quest sequence: 00750” is not displayed.

Further, as a correspondence between scenes that satisfy a specific condition by the player (e.g., during replay or during score attack), contents that are being played may be displayed in the specific play scene. As an example of such a configuration, in the case where the play score attack of the “area B” is performed in the situation of “before entry of the area A” as the progress of the game, by setting the priority higher than that of the main quest sequence to the specific play scene, during the play score attack, only the item associated with the “area B” is displayed, and the item associated with the “before entry of the area A” is not displayed.

Further, in the video game, in addition to the existing main story, a sub story may be added by a data table prepared for a story (Hereinafter, it is referred to as a “substory”.) different from the main story. In this example, the sub story progresses separately from the main story. Here, since there is a possibility that the player may proceed in parallel with respect to the main story and the sub story, it is desired to display appropriate items during the progress of the main story and the sub story. The following describes a case where items displayed in a dedicated browsing menu are switched in accordance with the progress of the substory.

Here, when a plurality of items are associated with each of the main story and the sub story, the items displayed in the dedicated browsing menu can be switched by specifying the items displayed in priority to the other items among the plurality of items according to the player's status (For example, the player's position in the tracking status of the story or the virtual space.). In the case of the display according to the tracking status, the item associated with the story being tracked is specified. Further, in the case of the display according to the player position, even when the substory is not tracked, when the query of the substory is ordered and the current place of the player is a predetermined place, the item associated with the substory is specified. When there are a plurality of identified items, a predetermined number of items are displayed from among them. A predetermined number of items may be displayed from among a plurality of identified items and other items. Further, according to the priority display status arbitrarily set by the player on the navigation display of the UI, an item displayed in priority to another item among a plurality of items may be specified.

When there are a plurality of substorys (for example, “substory A” and “substory B”), items are associated with the sequence of each substory. In this case, when a plurality of sequences satisfy display conditions as items, exclusive control may be performed according to a predetermined rule. That is, for example, when the items corresponding to the “cut scene”, the “main sequence” and the “subsequence B” satisfy the display conditions, only the items corresponding to either the “main sequence” or the “subsequence B” are displayed. That is, the cut scene is handled prior to the sequence. When the main story is in progress, items associated with the sub story may not be displayed.

In addition, a dedicated browsing menu may be used as a mechanism by which the player can arbitrarily read back with reference to a predetermined database. In this case, for example, a predetermined term may be registered in a predetermined database as a condition for displaying a description of a predetermined term on the player.

As described above, as one aspect of the second embodiment, since the server 10Z that controls the progress of the video game is configured to include the displaying unit 11Z, the extracting unit 12Z, the providing unit 13Z, and the updating unit 14Z, the server 10Z displays a game screen based on the progress status of the video game, extracts a description of a term corresponding to the progress status of the video game from a predetermined storage area based on information different from the text displayed on the game screen, and provides the extracted description of the term to the player, this makes it possible to provide more effective information to the player.

That is, by changing the content of the term in real time according to the progress status (For example, the location of the current location or the like is displayed after the progress of the game, the speech of the serif in the cut scene, the display of the place name UI, or the like is performed.) of the game, it is possible to realize a game in which the term is extracted in real time while the cut scene is flowing, and a game in which the current position of the player character is described. Thereby, it is possible to reduce the workload for the player to confirm the “important term appropriate for the player to grasp the game scenario” in the video game. Further, in the case where a plurality of stories are generated in parallel, it is possible to reduce the workload for the player to confirm important terms of other stories different from the stories being selected by switching display items with respect to arbitrarily selected terms.

Further, in the example of the second embodiment described above, a moving image (for example, a cut scene) to be reproduced is displayed without depending on the operation of the player, a description of a term corresponding to the reproduction status of the moving image is extracted from a predetermined storage area, and when a description request is received from the player, at least a part of the extracted description of the term is provided to the player, and the possibility that the progress of the video game continues while the player is not understandable can be reduced. That is, for example, when a player during a game inputs a description request by a predetermined operation, a function of displaying a description of a term in various game scenes can be activated, and a UI capable of browsing an item serving as a keyword according to the current main scenario status can be provided to the player.

Further, in the example of the second embodiment described above, it is possible to extract a description related to a position of the player or the character operated by the player in the virtual space from a predetermined storage area, and to provide information with a high possibility that the player wishes to know.

Further, in the example of the second embodiment described above, when the reproduction status of the moving image satisfies a predetermined update condition, the description of the term to be extracted is changed, at least one display item corresponding to the extracted description of the term is displayed, and when the display item is selected by the player, the description of the term is displayed, and the display item (e.g., keyword) can be changed according to the update condition (e.g., dialogue was played or UI caption display was selected), according to the situation of the video game, information with high priority can be provided to the player. In other words, the number and contents of information to be provided vary depending on the situation of the player, and from the viewpoint of the method of outputting and displaying information, more useful information can be provided to the player.

Further, in the example of the second embodiment described above, based on the progress of the video game by the player, the description corresponding to the player is updated, the description before updating or the description after updating is extracted according to the kind of the term, and it is possible to prevent the player from being detached by the description.

In the example of the second embodiment described above, when a plurality of descriptions of a term are extracted, a predetermined number of descriptions or description display items are displayed in accordance with a predetermined priority rule, thereby preventing a decrease in visibility of the game screen. That is, depending on the timing at which the player opens the UI, the displayed terms (or the number of icons corresponding to the terms) and the contents of the description that can be viewed may change. Further, in order to provide the player with a feeling of operation as a fluidly changing UI, a game screen in which a plurality of terms are arranged in a swaying manner may be displayed. As an example of a display form of each term, a term name and an image corresponding to the term are displayed in a circular frame.

As described above, each embodiment of the present application solves one or more problems. The effect according to each embodiment is an example of a non-limiting effect or effect.

In each of the above-described embodiments, the plurality of player terminals 20, 201 to 20N and the server 10 perform the above-described various processes in accordance with various control programs (e.g., video game processing programs) stored in a storage device of the server 10.

Further, the configuration of the system 100 is not limited to the configuration described as an example of each of the embodiments described above, and for example, a configuration may be adopted in which a part or all of the processing described as the processing executed by the player terminal is executed by the server 10, or a configuration may be adopted in which a part or all of the processing described as the processing executed by the server 10 is executed by any of the plurality of player terminals 20, 201 to 20N (for example, the player terminal 20). For example, when all the processes described as the processes executed by the server 10 are configured to be executed by the player terminal 20, the server 10 becomes unnecessary, and the above-described various processes are executed by the player terminal 20 alone. Further, a part or all of the storage unit included in the server 10 may be included in any one of the plurality of player terminals 20, 201 to 20N. That is, some or all of the functions included in either one of the player terminal 20 and the server 10 in the system 100 may be included in the other one.

Further, the program may implement some or all of the functions described as examples of the above-described embodiments in a single apparatus that does not include a communication network.

### INDUSTRIAL APPLICABILITY

According to one embodiment of the present invention, it is useful to provide more effective information to a player.

What is claimed is:

1. A non-transitory computer-readable medium storing a video game processing program that, when executed, causes a server to perform:
controlling progress of a video game;
displaying a game screen based on a progress status of the video game;
extracting a description of a term corresponding to the progress status of the video game from a predetermined storage area based on information different from text displayed on the game screen; and
providing the extracted description of the term to a player.

2. The non-transitory computer-readable medium according to claim 1, wherein the program, when executed, causes the server to further perform:
displaying a moving image that is reproduced regardless of an operation of the player;
extracting a description of a term corresponding to a reproduction status of the moving image from the predetermined storage area; and
providing at least a part of the extracted description of the term to the player when receiving a description request from the player.

3. The non-transitory computer-readable medium according to claim 1, wherein the program, when executed, causes the server to further perform extracting a description related to a position of the player or a character operated by the player in a virtual space from the predetermined storage area.

4. A video game processing system comprising:
a communication network;
a server;
a player terminal;
one or more processors configured to:
control progress of a video game according to an operation of a player;
display a game screen based on a progress status of the video game;
extract a description of a term corresponding to the progress status of the video game from a predetermined storage area based on information different from text displayed on the game screen; and
provide the extracted description of the term to a player.

5. A non-transitory computer-readable medium storing a video game processing program for causing a player terminal to perform functions comprising:
controlling progress of a video game;
displaying a game screen based on a progress status of the video game;
extracting a description of a term corresponding to the progress status of the video game from a predetermined storage area based on information different from text displayed on the game screen; and
providing the extracted description of the term to a player.
